(19) United States
(12) Patent Application Publication
(10) Pub. No.: US 2008/0134811 A1
(43) Pub. Date: Jun. 12, 2008

(54) INSERTION ELECTRODE DEVICE

(75) Inventors: Jelena Milanovic, Fislisbach (CH); Philippe Ehrismann, Uster (CH)

Correspondence Address: STANDLEY LAW GROUP LLP, 495 METRO PLACE SOUTH, SUITE 210, DUBLIN, OH, 43017, US

(73) Assignee: Metter-Toledo AG, Griefensee (CH)

(21) Appl. No.: 11/951,019

(22) Filed: Dec. 5, 2007

(30) Foreign Application Priority Data
Dec. 7, 2006 (DE) 102006058069.9

(51) Int. Cl. G01D 11/00

(52) U.S. Cl. 73/866.5

(57) ABSTRACT

An insertion electrode device (1) is designed for installing a probe (2) in a medium to be measured, through a receptacle or a fitting (3) in the receptacle. The probe comprises a probe head (10) at an end opposite the measuring end of the probe. The fitting or the receptacle has an internal shoulder (34). In the probe's installed state, the internal shoulder serves as stop for the probe head. A spacer ring (33) and a sealing ring (36) are arranged along a shaft of the probe between the probe head and the internal shoulder. The spacer ring has a profile which, together with the probe shaft, forms a groove (37), In the installed state of the probe, the groove completely accommodates and compresses the sealing ring.

### CROSS-REFERENCE TO RELATED APPLICATIONS

This application claims a right of priority under 35 USC §119 from German patent application 102006058069.9, filed 7 Dec. 2006, the content of which is incorporated by reference as if fully recited herein.

### TECHNICAL FIELD

The invention relates to an insertion electrode device for the installation of a probe with substantially cylindrical probe shaft in a receptacle for a medium to be measured and/or in a fitting.

### BACKGROUND OF THE ART

Probes for insertion electrode devices of this kind can be electrochemical sensors such as oxygen probes, pH measuring electrodes, ion-sensitive probes or conductance probes etc. The probes mainly consist of glass. For the process control they are preferably installed in reactors, mixing tanks or in flow pipes where they are used to record the relevant parameters of a respective medium to be measured in the receptacle concerned. For this purpose the probes are frequently inserted in a housing or a fitting. This fitting serves for the holding, guiding and protecting of the probe; however, in particular, the fitting creates a connection between the probe and the receptacle in which the probe is installed, i.e. for example a reactor, a mixing tank or a flow pipe. So-called static fittings and retractable housing are distinguished. With the latter the probe can be retracted into a rinsing chamber in the installed state and cleaned during the process for the monitoring of which it is employed. In principle, probes can also be connected directly to a receptacle which in the present context will likewise be sub-summarised under the term insertion electrode device.

A so-called static housing or a static fitting is described in CH 673 895 A5, published in 1990. This fitting is part of an insertion electrode device, for example for the pH measurement or redox measurement and consists of a housing with an upper part and a lower part designed as immersion tube. The upper part of the housing for example can be fastened to a port of a reaction vessel by means of a union nut. In the housing a probe, for example a glass electrode, is arranged in such a manner that its shaft runs through the immersion tube and extends into the medium located in the reaction vessel. The glass electrode is secured in the housing by means of a nut and a supporting ring.

A fitting described above or even the connection port of a receptacle in which the probe is to be installed has an internal shoulder against which the probe is pushed during installation, through which its position in the fitting or in the receptacle is defined. Between the probe and the internal shoulder a spacer ring, preferably of a medium-resistant polymer material, and a sealing ring are generally arranged. The latter is in direct contact with the internal shoulder to prevent medium to be measured from entering the region of the probe head which comprises the electrical connections of the measuring probe or even leaking into the open. The purpose of the spacer ring is to impart the probe with a certain dimension of mobility in the plane vertical to its longitudinal axis, as a result of which the forces acting on the shaft of the probe, which frequently consists of glass, can be better absorbed during installation.

This does not always meet with success with devices according to the state of the art.

The object of the invention therefore is to make available an insertion electrode device for the installation or insertion in a cylindrical probe which seals the region of the probe head well against the medium to be measured and prevents the effect of forces on the probe shaft.

### SUMMARY OF THE INVENTION

This object is solved with the characteristics of the device claimed in the appended claims.

An insertion electrode device is designed for the installation of a probe with substantially cylindrical probe shaft in a receptacle for a medium to be measured and/or in a fitting. The probe comprises a probe head and the fitting or the receptacle is provided with an internal shoulder. In the installed state of the probe the internal shoulder serves as stop for the probe head that is the probe is pushed forward against the internal shoulder during the installation. Between the probe head and the inner shoulder, surrounding the probe, are arranged a spacer ring and a sealing ring. The spacer ring has a profile which together with the probe shaft forms a groove which, in the installed state of the probe, completely accommodates and compresses the sealing ring.

Here, compressing of the sealing ring particularly takes place in accordance with established directives or norms.

The spacer ring serves for the defined positioning of the probe in the fitting or, with direct installation of the probe in a receptacle, for the defined holding of the probe in the receptacle or in an end port of said receptacle. The sealing ring is integrated in the spacer ring, i.e. it is substantially accommodated completely by a groove which is formed by means of the profile of the spacer ring and the wall of the probe shaft which is substantially cylindrical. Thus the sealing ring on the one hand seals the connection fitting-probe against potentially entering medium while on the other hand, however, its position prevents the effect of forces on the probe shaft during the installation of the probe in the fitting or in the receptacle.

The probe head preferably comprises a probe head sleeve provided with an external thread, wherein the side of the spacer ring facing away from the internal shoulder in the installed state of the probe comes to bear against the probe head sleeve. More preferably the end face of the probe head sleeve lies on the end face of the spacer ring facing away from the internal shoulder, with the probe head sleeve end having an area available for contacting the end face of the spacer ring that is at least as large as the corresponding spacer ring end face.

In this manner the spacer ring can be designed symmetrically with regard to its mean ring plane as a result of which no attention to its orientation has to be paid during installation. In addition, the manufacture of such symmetrically formed spacer rings is preferred, in particular if a recess forming the profile of the spacer ring on both sides, which ultimately forms the groove together with the probe shaft, is rectangular in shape. In a preferred embodiment the width and the depth of the groove are adapted to the material diameter of the sealing ring in such a manner that they compress said sealing ring in the installed state of the probe in accordance with established directives. More preferably the width and the depth of the groove substantially correspond to the material diameter of the sealing ring.

In an advantageous further development of the insertion electrode device the fitting comprises a protective probe tube which serves for the accommodation, holding and guiding of the probe wherein the internal shoulder is formed in the protective probe tube.

In a particularly preferred configuration the protective probe tube is provided with an internal thread for fastening the probe in the fitting and the probe head has an external thread.

### BRIEF DESCRIPTION OF THE DRAWINGS

The invention is explained in more detail by means of the description of the exemplary embodiments shown in the accompanying drawings, where identical parts are identified by identical part numbers and wherein:

FIG. 1 shows a lateral section view of an insertion electrode device with a fitting along a longitudinal axis thereof and a probe;

FIG. 2 shows the insertion electrode device of FIG. 1 with a fitting and a probe in lateral view, for illustration of the assembly and disassembly; and

FIG. 3 shows a cut-out enlargement from FIG. 1 in broken representation, wherein the spacer ring and a part of the probe head are likewise drawn in section.

### DETAILED DESCRIPTION OF THE EMBODIMENT(S)

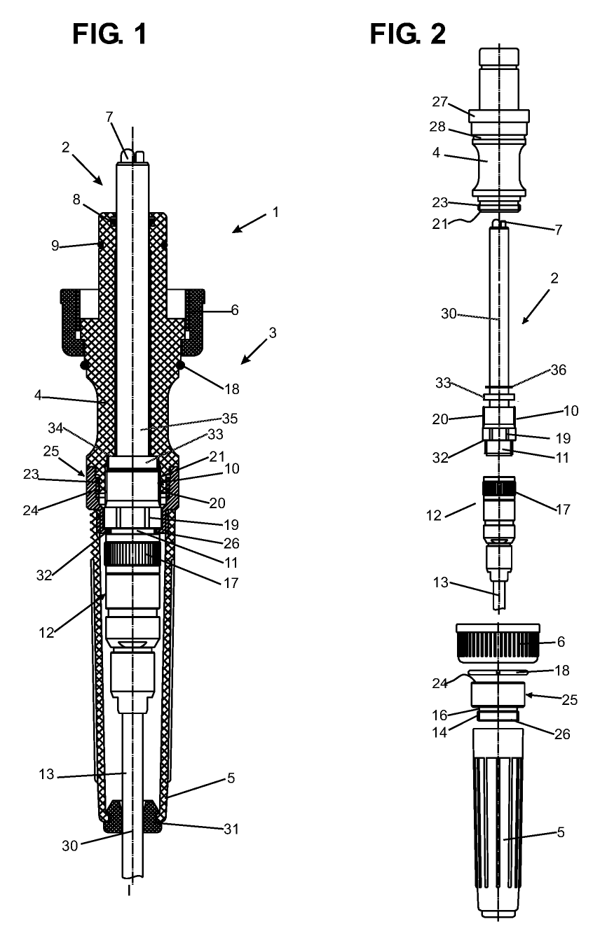

FIG. 1 shows an insertion electrode device 1 in a partial sectional drawing along a longitudinal axis 30. The insertion electrode device has a static fitting 3 suitable for the insertion of a substantially cylindrical probe 2, in particular a glass electrode. The static fitting 3 surrounding the probe 2 has a protective probe tube 4 and a protective sleeve 5. A process adapter 6 is located close to the end of the fitting 3 that faces a receptacle into which the probe 2 is to be installed. Process adapter 6 is depicted in FIG. 1 as a union nut. With this process adapter 6, the fitting 3 is screwed to a connection port of a corresponding receptacle (not shown here). Thus, a part of the protective probe tube 4 reaches into the receptacle. A probe 2 guided in this protective probe tube 4 likewise extends into the receptacle and extends beyond the protective probe tube 4, allowing immersion of a measuring element 7, depicted in FIG. 1 as a membrane, located at the probe tip, in the liquid to be measured. A first sealing ring 8 prevents entry of the liquid to be measured into a space between the probe 2 and the protective probe tube 4. A second sealing ring 9 seals a space between the protective probe tube 4 and the connection port of the receptacle. A third ring 18 displaceably holds the process adapter 6 in its position on the protective probe tube 4.

At its end which during an installation in the process is located outside the receptacle, i.e. the end below the process adapter 6 in FIG. 1, the probe 2 has a probe head 10 which has a connection port 11 connecting a cable 13 that serves as an electrical supply line, provided with a plug 12. The probe head 10 has a hexagonally shaped region 19 so that manual gripping and holding for establishing the plug connection can be performed here. The plug 12 has a knurled sleeve 17 with internal threading (not visible here), by means of which through screwing onto an external thread (likewise not visible here) of the connection port 11, the plug connection is secured.

The probe 2 is threadingly connected inside the protective probe tube 4 with external threading 20 on the probe head and a corresponding internal threading 21 inside protective probe tube 4. An external threading 24 is located at the same end of the protective probe tube 4, for fastening of the protective sleeve 5, by means of an internal threading 23, which is preferably provided in a connecting part that is permanently connected to the protective sleeve 5, for example, through a bonded connection. Obviously, protective sleeve 5 could also be designed in one piece in this place. The connection of the protective sleeve 5 with the protective probe tube 4 is additionally provided with a sealing compound during screwing-on in order to mainly avoid the entry of moisture in the connecting region of the electrical connection of the probe 2. When released from the probe protection tube 4, the protective sleeve 5 can be relocated along the cable 13 and also turned to establish the screw connection about the cable 13 since it has a substantially sealing yet flexible grommet 31, preferentially consisting of rubber, in the region of the cable passage.

A safety adapter 25 is introduced between the protective probe tube 4 and the protective sleeve 5. The safety adapter 25 has a collar 26 that faces inside to the longitudinal axis 30 of the insertion electrode device 1 which in the installed state surrounds the hexagonally shaped region 19 of the probe head 10 in particular the shoulder 32 formed between the hexagonal region 19 and the region of the connection port 11 protruding from this region and preferably supports itself on said shoulder. Thus the probe 2 is held fixed in its installed position in the protective probe tube 4. Through this embodiment of the safety adapter 25 both the assembly of the fitting 3 and the probe 2 as well as their disassembly are positively predetermined and no operations can be mixed-up.

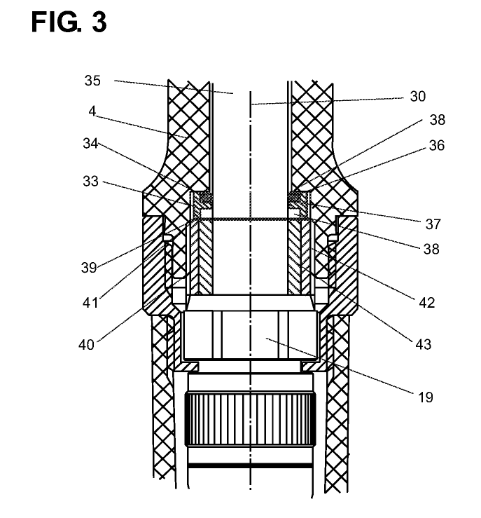

A spacer ring 33 is located between probe head 10 and an inner shoulder 34 of the protective probe tube 4. The spacer ring 33 serves for the defined holding of the probe 2 in the fitting 3 or in an installation port of a receptacle, not shown here, in the case that the probe is directly installed in such. An additional sealing ring not visible in FIG. 1 is located in contact with the inner shoulder 34 and completely lies in a groove which in the installed state of the probe is formed together by a recess in the spacer ring 33 and the probe shaft 35 as is explained further down by means of FIG. 3.

FIG. 2 shows an insertion electrode device 1 in lateral view in the disassembled state. Components which are identical to those described by means of FIG. 1 are marked with the same reference numbers and are not described again at this point. As is evident in the middle of the Figure, the additional sealing ring mentioned above—hereinafter referred to as sealing ring 36—is to be arranged for the installation of the probe 2 in a fitting 3 surrounding the probe at its probe shaft 35 between the spacer ring 33 and the protective probe tube 4.

FIG. 3 shows a part sectional drawing as cut-out enlargement of FIG. 1 in which the parts of the fitting 3 and the probe head 10 relevant to the invention as well as the spacer ring 33 and the sealing ring 36 are shown in a sectional view. It is clearly visible that the sealing ring 36 is completely accommodated by the groove 37 which in the installed state of the probe is formed together by a recess 38 in the spacer ring 33 and the probe shaft 35. In this manner it is ensured that the compression of the sealing ring 36 is defined and thus a defined torque during screwing-in of the probe 2 in the fitting 3 is achieved. As a consequence, undesirable forces on the probe shaft 35 are avoided.

The spacer ring 33 is designed symmetrically with regard to its mean ring plane vertically to its symmetry axis which upon correct insertion corresponds to the longitudinal axis 30 of the insertion electrode device 1. This means the recess 38 which in interaction with the probe shaft forms the groove 37 is also present on the side of the spacer ring 33 which faces away from the internal shoulder 34. In this way an end face 39 is formed which is flush in contact with an end face 41 of a probe head sleeve 40. The probe head sleeve 40 on the one hand has an external thread 42 by means of which it is screwed together with the protective probe tube 4 of the fitting 3. Inside, the probe head sleeve 40 is screwed to a holder 43 which is permanently connected, preferentially bonded, with the probe shaft 35 and simultaneously with the connection port 11. The fact that the spacer ring is merely in contact with the probe head sleeve 40 and not with the holder 43 permanently connected with the probe shaft 35, results in that no forces act on the probe shaft 35 when the probe 2 is being screwed together with the fitting 3.

The insertion electrode device was described by means of the example of a static fitting. It is to be understood per se that the insertion electrode device can also comprise other fittings not described in any more detail here. The direct installation of a probe in a receptacle, in particular by means of a connection port on the receptacle, shall also be encompassed by the insertion electrode device according to the invention. In addition, the invention is not restricted to insertion electrode devices whose connections, in particular those between probe and fitting, or between probe and the connection port of a receptacle, are performed by means of a screw connection. The connections can for example be realised each on its own or several simultaneously in form of a bayonet closure.

What is claimed is:

1. An apparatus for installing a measuring element into a medium to be measured, through at least one of a receptacle or a fitting attachable to the receptacle, the apparatus comprising:
an internal shoulder formed in the receptacle or the fitting attachable to the receptacle;
a probe, comprising a substantially cylindrical probe shaft with the electrode membrane at one end and a probe head at the other end;
a spacer ring, surrounding the probe shaft and positioned thereon between the probe head and the electrode membrane, the spacer ring having a profile such that the spacer ring and the probe shaft define a groove that faces the electrode membrane end of the probe; and
a sealing ring, surrounding the probe shaft and positioned thereon between the spacer ring and the electrode membrane;
such that the internal shoulder serves as a stop for the probe head when the probe is installed in the receptacle or the fitting and the spacer ring and the groove completely accommodates and compresses the sealing ring when the probe is in the installed position.

2. The apparatus of claim 1, wherein:
the probe head comprises a probe head sleeve for attachment to the receptacle or the fitting in the installed position, and
the spacer ring has an end face, opposite the groove, that contacts the probe head sleeve, and not the probe shaft, during attachment to the receptacle or the fitting, preventing direct force on the probe shaft.

3. The apparatus of claim 2, wherein:
the probe head sleeve comprises an end face for contacting the spacer ring end face, an area available for contact on the probe head sleeve end face being at least as large as a corresponding area on the spacer ring end face.

4. The apparatus of claim 3, wherein:
the spacer ring is symmetrical with respect to a median ring plane thereof.

5. The apparatus of claim 4, wherein:
the groove has a rectangular profile.

6. The apparatus of claim 5, wherein:
the groove has a width and a depth that are matched to the dimensions of the sealing ring.

7. The apparatus of claim 6, wherein:
the width and the depth of the groove correspond to the material diameter of the sealing ring in the installed position of the probe when the probe head sleeve is tightened to a predetermined torque.

8. The apparatus of claim 7, wherein:
the internal shoulder is formed in a protective probe tube that defines the receptacle or the fitting, the protective probe tube serving to accommodate, hold and guide the probe.

9. The apparatus of claim 8, wherein:
the protective probe tube has internal threading for engaging the external threading on the probe head sleeve.

10. The apparatus of claim 1, wherein:
the spacer ring is symmetrical with respect to a median ring plane thereof.

11. The apparatus of claim 1, wherein:
the groove has a rectangular profile.

12. The apparatus of claim 1, wherein:
the groove has a width and a depth that are matched to the dimensions of the sealing ring.

13. The apparatus of claim 1, wherein:
the width and the depth of the groove correspond to the material diameter of the sealing ring in the installed position of the probe when the probe head sleeve is tightened to a predetermined torque.

14. The apparatus of claim 1, wherein:
the internal shoulder is formed in a protective probe tube that defines the receptacle or the fitting, the protective probe tube serving to accommodate, hold and guide the probe.

15. The apparatus of claim 14, wherein:
the protective probe tube has internal threading for engaging external threading provided on the probe head.
